(19) United States
(12) Patent Application Publication
(10) Pub. No.: US 2006/0101162 A1
(43) Pub. Date: May 11, 2006

(54) Method and device for adapting a computer program to a device on which it is installed

(75) Inventors: Geir Ivarsy, Oslo (NO); Snorre Grimsby, Skjetten (NO)

Correspondence Address: BIRCH STEWART KOLASCH & BIRCH, PO BOX 747, FALLS CHURCH, VA, 22040-0747, US

(73) Assignee: OPERA SOFTWARE ASA, OSLO (NO)

(21) Appl. No.: 10/982,953

(22) Filed: Nov. 8, 2004

(51) Int. Cl. G06F 3/00

(52) U.S. Cl. 710/8

(57) ABSTRACT

A cross platform method and programming architecture that enables a program to be adaptable such that it can be universally implemented on devices of varying characteristics and functionality. The various characteristics and functionality may include varying display resolutions, display sizes, font availability etc where the adaptability of the method and programming architecture allows documents to be displayed in a visually appealing manner, without requiring specific defined instructions and programming for each individual device.

### BACKGROUND OF THE INVENTION

1. Field of the Invention

The present invention relates to cross-platform programming of computer programs. More specifically the invention relates to a novel method and programming architecture for enabling dynamic adaptation of computer programs to changing hardware or user requirements. In a particularly relevant embodiment, a computer program is configured to dynamically change the rendering of a formatted document in response to a changing hardware or software environment.

2. Description of Relevant Art

When programming the same application for several platforms or different devices, programmers have to take into consideration the varying resources and capabilities of the new platform or device. This may include resolution, available fonts, number of colors, etc. Traditionally, this has been accomplished through hard coding of device- or environment-dependent parameters prior to compilation of the source code.

A typical example of this approach would be when a particular computer program is developed for several types of devices, such as desktop computers as well as PDAs. The desktop version could be programmed to display fonts the way they are formatted in a document, while a PDA version could be programmed to reduce the size of any font larger than a certain maximum font size. As the number of such parameters grow, the difference between versions also grows. Furthermore, as the number of classes of devices grow, so does the number of versions of the computer programs necessary in order to be able to run the program on as many different devices as possible.

Additional difficulty is introduced when the user is able to configure or otherwise change the computer program dynamically while it is running. Expanding on the above example, some devices may be able to display fonts according to the original formatting of a document if the user interface window, where the program presents the document, is larger than a certain minimum size. However, if the user reduces the size of the window, reformatting of font sizes may be necessary in order to render the document in a manner that makes it possible for the user to get a meaningful view of the document.

Therefore, based on traditional approaches to implementing the same application for various platforms and devices would require writing a large number of versions of the computer program, and to include a large number of conditions e.g. in the form of regular expressions, as well as environment variables in the source code of the computer program.

### SUMMARY OF THE INVENTION

The present invention provides a method for simplifying development of computer programs for several platforms or devices by including conditional expressions in the code of the computer program making the program capable of selecting between operational modes based on the environment in which it is operating. The present invention is also directed to a computer program product and a device operating according to the method.

According to the method of the present invention, a computer program is made capable of adapting to a device on which it is installed. This is done by providing, in the code, of said computer program one or more conditional expressions for selecting one out of a plurality of operational modes for said program, providing, on said device, one or more configuration values to be included in said conditional expressions, at least some of said configuration values defining conditions for transitions between said plurality of operational modes; and during execution of said program, providing as input to said conditional expressions, values representing one or more states in which the device is operating.

According to one embodiment, the configuration values are included in the code of said computer program.

According to a preferred embodiment of the invention, greater flexibility is provided by including the configuration values in a configuration file stored on the device. While it will be understood that while alternative operational modes defined in the code of the computer program itself will provide the computer program with the capability of adapting to a certain predefined set of devices, storing configuration values externally to the program code will make it possible to change configuration parameters at some later time without changing the program code, e.g. in order to make the computer program capable of adapting to new types of devices.

According to one embodiment the configuration values are downloaded from a remote location with which the device is capable of communicating.

In addition to configuration values that define transitions between operational modes, a further embodiment includes configuration values that define parameters to be applied in a given operational mode.

In an exemplary embodiment, the environment variables are associated with the display of the device on which the computer program is running. In this embodiment the configuration values may be parameters such as minimum or maximum values that determine to what extent content, such as a document, should be displayed according to its original formatting, and whether some formatting should be overridden.

According to an embodiment, such parameters could indicate whether or not images should be displayed, the maximum number of columns to be displayed, maximum font size, etc.

According to the invention, the conditional expressions in the computer program code may be regular expressions or other conditional statements that define a plurality of modes. In each mode a different set of parameters apply.

In an exemplary embodiment where the variables are associated with the display of the device on which the computer program is running, the conditions are preferably associated with window size or resolution.

According to an embodiment, the conditions, or switches, establish two or more rendering modes within which different sets of parameters for the environment variables apply. For example, when the display window is smaller than a defined minimum size, images should not be displayed, text should always be shown in one column only, and fonts should never be displayed larger than a defined maximum size. When the display window size is above this defined minimum, the original formatting of the document applies. If more than two rendering modes are used, an intermediary mode could display a maximum of two columns, display images at half size, and display fonts at original size.

According to an embodiment different rendering modes are associated not with the window size, but with window orientation, i.e. whether the device displays the user interface in portrait mode or in landscape mode.

According to an embodiment of the invention, one of the parameters of a rendering mode is minimum text contrast, which is a minimum allowable difference in brightness between text and background colors. If normal rendering results in a text contrast less than the minimum text contrast, the text color, the background color, or both, will be adjusted so that the minimum text contrast is fulfilled. A condition for whether to apply minimum text contrast or not, could be whether or not the display is, or operates as, a black and white or monochrome display.

According to an embodiment, one of the parameters of a rendering mode is to apply table column shifting. Table column shifting reformats tables that are wider than the display width by generating additional table rows, shifting cells that fall outside the display window to the additional table rows, and maintaining any vertical alignment between shifted cells.

According to the invention, the computer program is a program capable of rendering on a device display a representation of a document present on the device as a markup file, i.e. a file formatted according to a markup language such as SGML, WML, HTML, DHTML, XHTML, or XML, or as a word processing file. The various operational modes may then be rendering modes including alternative sets of rules for the spatial representation of the file on the display.

### BRIEF DESCRIPTION OF THE DRAWINGS

Exemplary embodiments of the present invention will become more fully understood from the detailed description given hereinbelow and the accompanying drawings. These drawings are given by way of illustration only and, thus, are not limiting on the present invention. In these drawings, like reference numerals represent like elements, wherein:

FIGS. 1a-b illustrates a document presented in a computer window;

FIG. 2 is a block diagram of a device according to an exemplary embodiment of the invention;

FIG. 3 illustrates an alternate view of the document of FIGS. 1a-1b;

FIG. 4 is a flow chart of the implementation within a device of an exemplary embodiment of the invention; and

FIGS. 5a-b illustrates the implementation of table shifting according to an embodiment of the invention.

### DETAILED DESCRIPTION OF EXEMPLARY EMBODIMENTS

The present invention is directed to a method for adapting a computer program's behavior to certain parameters of its hardware and/or software environment, or to a particular user mode selected by a user. In this specification and in the attached claims this will be referred to as adapting to a device, but it must be understood that the parameters that determine the program's behavior do not have to be intrinsic to the device itself; it could also be a state in which the device is operating as determined by device hardware, environment variables, additional software with which the computer program is capable of interoperating, characteristics of data operated on by the computer program, user choices, or any combination of such factors. In other words, the phrase adapting to the device is intended to include any adaptation to a permanent or temporary condition existing on the device.

According to the present invention, instead of being designed specifically for the device in question directly in the program code, the code contains variables and/or expressions that can influence the operation of the program in accordance with values read into these variables or expressions. These configuration values define transitions between a plurality of operational modes and are stored on the device on which the computer program is installed. The configuration values may be part of the program code, but preferably they are provided externally to the computer program, for instance in a configuration file. The values in the configuration file will be read into the computer program when the program executes, and the program will behave as if it was specifically designed for the device or platform on which it is currently installed.

For example, a computer program may be capable of displaying the contents of a document on the display of a particular device. However, the document may be formatted or otherwise designed to be displayed on a regular desktop computer, while the device on which the computer program is installed could be a laptop computer, a PDA, or even a mobile phone. Furthermore, these devices may be capable of operating in different modes, such as a portrait and a landscape mode, with resized windows etc. If the document is displayed according to its native formatting in all these different devices and modes, the presentation to the user will be highly variable.

A file can also include device-independent values with conditions that allow a computer program to adapt dynamically to changing conditions or varying devices. For example, the computer program may be stored on a central computer and run on terminals with varying screens. Or it may run on a device that has several different ways of presenting documents, such as screens, printers, and audio, which means several ways of reformatting documents would be needed.

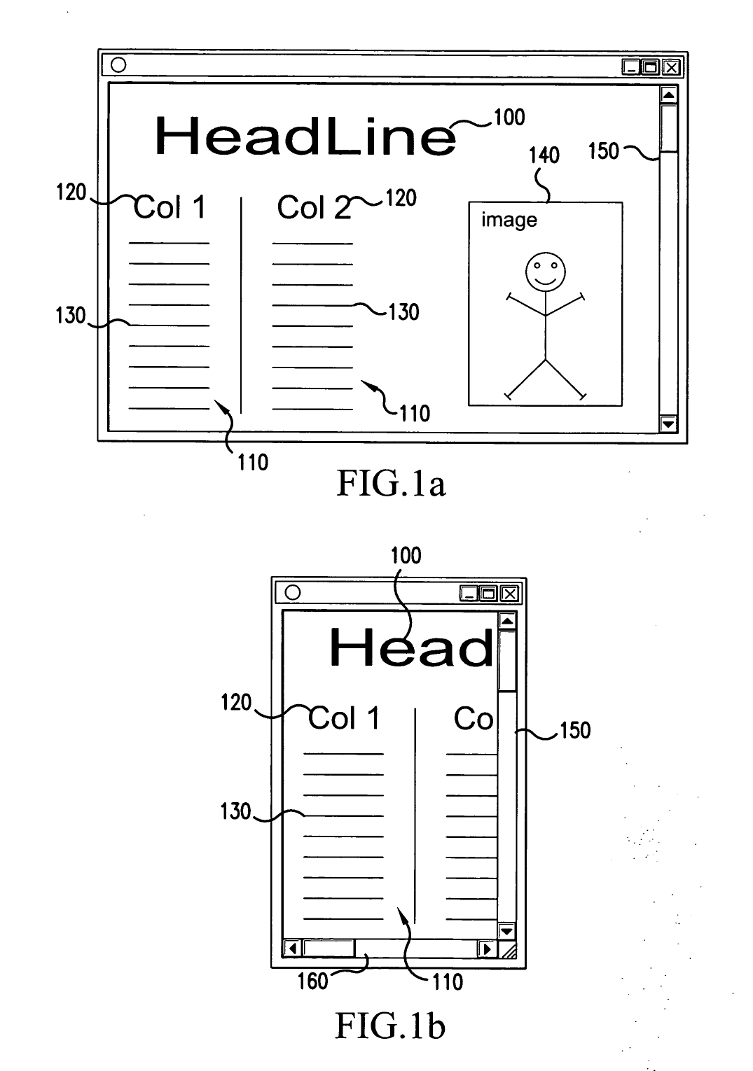

FIG. 1a illustrates how a document, such as e.g. a Web page (markup document) or a word processing file may be presented in a window on a desktop computer. The document includes a headline 100 in a large font, two columns 110 each with smaller headlines 120 and body text 130, and an image 140. The window also includes a vertical scroll bar 150 for scrolling down through the document.

FIG. 1b shows what the same page or file would look like without the benefit of the present invention if the window is smaller, as it would be, for example, on a PDA. Only part of the headline 100, the first column 110 including column headline 120 and body text 130 are displayed. In addition to the vertical scroll bar 150, a horizontal scroll bar 160 appears, making it possible to scroll horizontally so the second column and the image 140 become visible in the display. Horizontal scroll bars are often very inconvenient to the user and represent one of the problems of the prior art.

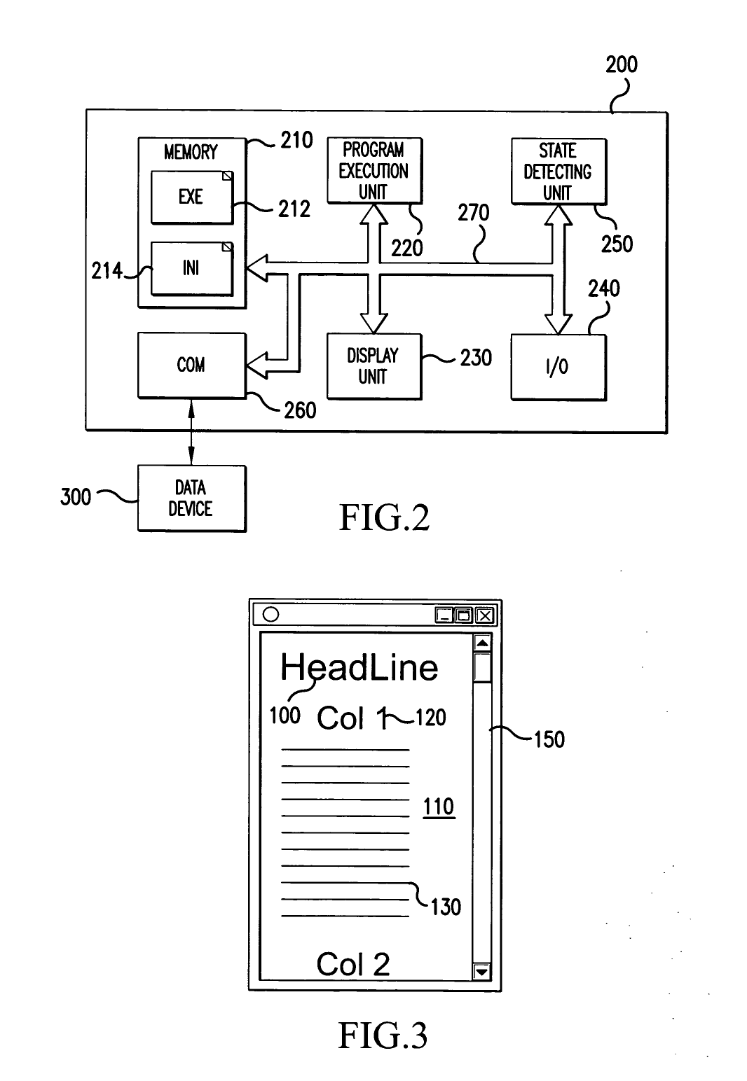

FIG. 2 illustrates in a block diagram a device 200 operating according to the invention. It should be noted that the functional units shown here are exemplary only, and should not be construed as limiting on the present invention. The actual units and modules here shown could be implemented as any combination of hardware and/or software, combined into fewer or split up into additional components.

It should also be noted that FIG. 2 is not meant to exhaustively show all of the functional units used in the device 200. Instead, FIG. 2 is merely illustrative of the basic units used for implementing the invention. As will be readily understood by those of ordinary skill in the art, certain functionality or components that are not shown in FIG. 2 will be understood to be part of such a device, including, for example, basic operating system functionality, display drivers, and a window manager program.

According to the exemplary embodiment of FIG. 2, a memory unit 210 contains the computer program code 212 and a configuration file, e.g. an ini-file 214. The memory unit 210 may also provide necessary working memory for a program executing unit 220 during execution of program instructions. The memory unit 210 may also store any software part of additional components or modules of the device described below.

The program executing unit 220 is capable of reading and executing the instructions of the computer program code 212 and of reading the configuration values stored in the configuration file 214. A display unit 230 is capable of displaying visual output data resulting from the execution of program code instructions by the program executing unit 220. An input/output unit 240 may include a user interface that may operate in cooperation with the display unit 230 that may, for example, be a touch screen. A state-detecting unit 250 is a device or a module capable of reporting the values of environment variables, received type codes or other states or values that may correspond with one or more configuration values or conditions in the configuration file 214, as will be explained in further detail below. It should be noted that this state-detecting unit 250 is presented here as a single logical unit for clarification purposes in explaining the embodiments of the invention. In embodiments of the invention, this unit can be a combination of functionality located in various parts of the device, such as the operating system, the window manager, the display driver, or the computer program 212 itself, and it may not even be logically identifiable as a separate device.

Also included in this exemplary embodiment is a communications unit 260, capable of communicating with one or more separate data devices 300 and receiving data from the data devices 300 for processing by the program execution unit 220 and displaying on the display unit 230. The communications unit 260 could also be capable of receiving updated configuration values from such a separate data device 300 or from a remote location (not shown) with which the device 200 is capable of communicating. All the units of the device are connected by a data bus 270.

According to the prior art, the computer program code 212 would be programmed to operate on the device it is installed. This means that when writing the source code, a programmer would have to take into consideration the capabilities of the intended device, such as screen size and resolution, window resizing capabilities, and fonts, and possibly also number of colors, contrast, media and data types the device is capable of handling, communications ports and protocols, user input interfaces, and any number of other parameters that may be relevant.

In accordance with the teachings of the invention, the source code may instead be written so that the computer program becomes capable of adapting to the device on which it is installed, and preferably also to adapt dynamically to changes in the way the device is used. This means that instead of writing, for example, a separate version of the computer program for devices with small screens, the code could include conditional expressions that receive input values from the device representing the size of the screen and determine the behavior of the computer program accordingly. Preferably, the conditional expressions may include variables that may be changed from outside the computer program, e.g. based on values in a configuration file, making it possible to define and redefine under which conditions the various operational modes should apply. Similarly, any value that defines what a given operational mode should result in can be implemented in the code of the computer program, or it may be defined outside the computer program, again for example in a configuration file.

From the above description it will be understood that there are two types of configuration values. One type helps define when the computer program should operate in one operational mode or another, the other type helps define what operating in a given operational mode actually means. Continuing with the above example, one configuration value could define the screen size below which a computer program should operate in a small screen mode, another configuration value could define that when the computer program operates in this small screen mode the maximum font size should be set at a particular value and larger fonts should be reduced in size.

Furthermore, the invention allows the input to the conditional expressions of values received from the device in order to by compared with or otherwise evaluated against the configuration values, to not only be static values representing e.g. hardware limitations of the device, but also dynamic values such as the size of a resizable window, some type data identifying the content to be displayed, whether sound is turned on or off, the orientation of the display in a landscape or a portrait mode, or any number of other environment variables or other static or dynamic information representative of the conditions under which the computer program is operating.

It will be understood, then, that based on configuration values that define a plurality of operational modes and values representative of the conditions currently existing on the device, the conditional expressions makes it possible to determine whether a particular mode of operation applies. Based on the outcome of this determination and on configuration values that impose conditions or parameters to be applied in these different modes, the computer program can then adapt dynamically to the environment and choose between two or more alternative modes of operation.

As an example assume that the window size, in which the computer program is currently displaying a document, is smaller than 300 pixels in width, and the maximum font size is 24 points (i.e. fonts larger than 24 points should be reduced to 24 points). If the window is equal to or larger than 300 pixels in width, the device should display all fonts at the size dictated by formatting native to the document, meaning maintaining the original format variables of the document. This can be expressed in pseudo code as follows:

```
If window_size < 300 {
    max_font = 24;
}
else {
    apply_native_formatting;
}
```

However, to create even greater flexibility, the limit at which the maximum font size applies can be made dependent on the device, and so can the actual font size of the maximum font. These values can be stored on the device, for example, in a configuration file. The configuration file may look something like the following and may be implemented into a computer program:

[Screen]

min_size=300

max_font_size=24

and the computer program code:

```
if window_size < min_size {
    max_font = max_font_size;
}
else {
    apply_native_formatting;
}
```

Elsewhere in the program code there can be instructions for enforcing the maximum font size whenever the document contains larger fonts.

It will be understood that in embodiments of the invention, the program code can be written to ignore one or more of the values in the configuration file. This could be convenient if two or more programs share the same configuration file, but still adapt slightly differently to the device, or when a configuration file is written for a class of devices and some variables do not apply to this particular device. Conversely, the configuration file can be written to enforce certain conditions at all times even if they in theory are dynamic (as will be described below). If, for instance, the minimum window size for normal rendering is set larger than the actual display size of the device, the maximum font size will always apply.

When the computer program 212 is started, the program execution unit 220 will read all the values stored in the configuration file 214 and store them in memory locations in the memory device 210 allocated to the corresponding variables in the computer program 212. Whenever the execution of the computer program encounters conditional expressions taking any of these variables into consideration, the program execution unit 220 will retrieve any relevant environment variables from the state-detecting unit 250 (e.g. actual window size) and evaluate the conditional expression, e.g. compare actual window size with minimum window size. If this evaluation indicates that a condition applies, the condition will be enforced, for example, if the actual window size is smaller than minimum window size, a maximum font size will apply. The result will be visible to the user when the document is rendered on the display device 230.

Other parameters that could be controlled based on window size include number of columns, image resizing or whether to display images at all, whether or not to apply style sheets, whether to use or override color information in the document, etc.

According to one embodiment of the invention the device includes a communications unit 260 that is able to communicate with another data device 300. The communications unit 260 may may include one or more standardized communication ports. For instance, the communications unit 260 may include a Bluetooth port, an IrDA port, a USB port, and/or an RS-232 port.

The data device 300 may be any device capable of delivering data for processing and/or display on the device according to the invention. It is assumed in this example that the device according to the invention is capable of communicating with different types of data devices and receive different types of data for display. According to this embodiment of the invention the device is capable of identifying the type of data received. This is done by the state-detecting unit 250 which extracts or generates type data from the information received from the data device 300, and forwards it to the program execution unit 220. The type data may then be taken into consideration during execution of the computer program 212 as described above.

An example of type data, or type codes, that could dictate a certain reformatting could be certain graphical input from, for example, a GPS or some other device producing images too large to be displayed on the screen of the device 200. It may be undesirable to resize all types of graphical input according to the same rule; some images are best viewed at their intended size and with scroll bars 150, 160, while other types of images should be resized. Other type data could dictate a change in contrast, number of colors displayed, or even whether sound should be enabled.

FIG. 3 shows an alternative view of the page shown in FIG. 1. As in FIG. 1b the window is smaller than the window size for which the page has been designed. However, based on formatting rules stored in a configuration file 214, in combination with instructions in the computer code, the computer program 212 has been able to determine that the window width is below a certain minimum for applying native document formatting. Instead, the document has been reformatted. The headline 100 has been resized so the entire headline is visible in the smaller window. Furthermore the columns have been reduced to one, i.e. the second column has been placed below the first column, and the image has been placed below the text. The second column and the image are not shown in FIG. 3 but their repositioning is indicated by the disappearance of the horizontal scroll bar 160. Using the vertical scroll bar 150 would bring the second column and eventually the image into the display.

It should be noted that in the above description, and elsewhere in this specification, reformatting does not refer to any actual transformation of the original data. If, e.g. the data is a markup file (HTML, XML or similar), this file will remain unchanged and only the actual rendering of the data on the device will change.

A configuration file for the rendering mode illustrated in FIG. 3 could look like the following:

[RM1]

min_size=240

max_font_size=18

columns=1

show_images=1

image_resize=200

In this example min_size is the window width, in pixels, below which the reformatting rules should apply, max_font_size is the maximum font size to which the headline 100 has been reduced, columns is the maximum number of columns, show_images is a boolean indicating that images should be shown, and image_resize is a maximum image width to which images should be reduced if they are larger. Preferably the aspect ratio will be maintained, but in some use cases, for example, where images are used to show abstract design features of a page or a user interface, it may be preferable to reduce the image size only in the horizontal direction.

In a basic implementation of the invention, the configuration file 214 provides one or more parameters that will be implemented every time the computer program 212 is executed on the device 200. As an example, the configuration file could indicate that particular device images should never be displayed, or fonts should never be larger than 18 point. According to one embodiment of the invention, the computer program 212 is capable of dynamically adapting to different sets of parameters based on dynamic changes in the state of the device. For example, the size of the window in which the computer program 212 is displayed to the user can be dynamically resized by the user, e.g. by means of the input/output unit 240. In this case the state-detecting unit 250 detects the window size and reports it to the program execution unit 220. The program execution unit 220 will take the latest reported window size into consideration whenever a conditional expression is encountered during execution of the computer program 212, and display document data accordingly.

According to one exemplary embodiment the configuration file identifies four different conditional rendering modes, with normal rendering, i.e. rendering according to the formatting native to the document, as a fifth rendering mode. The rendering modes could be defined as indicated in table 1:

| Parameter | RM1 | RM2 | RM3 | RM4 | Normal |
|---|---|---|---|---|---|
| Window width | 0-119 | 120-319 | 320-639 | 640-799 | 800 -> |
| Font size | 12 | 18 | 24 | 24 | Normal |
| Images | 0 | Some | Normal | Normal | Normal |
| Image resize | N/A | 80.00% | 80.00% | Normal | Normal |
| Columns | 1 | 2 | 3 | Normal | Normal |
| CSS | No | No | Yes | Yes | Yes |

In the table above window width indicates the window sizes (horizontal pixel width) at which the rendering mode applies. Font size is maximum font size for that mode. Images indicate whether or not images should be displayed, “some” indicating that e.g. the first few images or only images with a certain size should be displayed, e.g. the first four. Image resize indicates the size at which the image should be displayed, as a percentage of the window width, which means that the image will be dynamically resized within the rendering mode. Columns gives the maximum number of columns to be displayed. CSS refers to Cascading Styles Sheets, files that define formatting that may be shared between several documents, and indicates whether such style sheets should be applied. In all cases “Normal” means that the formatting native to the document should be applied.

The relevant part of a configuration file for the above example could look like the following:

[RM1]

window_size=120

max_font_size=12

images=0

columns=1

css=0

[RM2]

min_window_size=320

max_font_size=18

images=4

image_resize=0.8

columns=2

css=0

[RM3]

min_window_size=640

max_font_size=24

images=−1

image_resize=0.8

columns=3

css=1

[RM4]

min_window_size=800

max_font_size=24

images=−1

image_resize=−1

columns=−1

css=1

In the example above most of the values are self explanatory when compared to table one. When a value of −1 is entered this indicates that the formatting native to the document or data to be displayed should be used. Alternatively these variables could be left out of the configuration file altogether and page formatting could be default for all values not assigned. Another alternative would be to define categories in the code of the computer program 212 and just indicate the category in the configuration file 214. For instance, while images in the example above is given as the number of images to display, the values for this variable in the configuration file could be 0, 1 and 2, to be interpreted according to rules encoded in the computer program 212 as none, some and all, respectively.

According to the example above, there are a total of five different rendering modes. The conditional expression in the conditional statements or expressions evaluating and implementing these can be illustrated in pseudo code as follows:

```
/* Read configuration file */
i = 1;
repeat {
rm(i) = min_window_size;
    i = ++;
    number_of_modes;
  }
  until end of file;
  /* Apply rendering mode */
  read window_size from state_detecting_unit;
  rendering_mode = number_of_modes;
  for (i = 1; i <= number_of_modes; i++) {
    if window_size < rm(rendering_mode) then rendering_mode =
rendering_mode − 1;
  }
  switch (rendering_mode) {
    case ‘0’:
      apply RM1;
    case ‘1’:
      apply RM2;
    case ‘2’:
      apply RM3;
    case ‘3’:
      apply RM4
    default:
      apply native formatting;
}
```

In the example above the execution of the computer program 212 makes the program execution unit 220 read the configuration file 214 sequentially from beginning to end. Every time it encounters a variable named “min_window_size” the value of this variable is stored in the next free position in an array named rm( ). The result will be an array that lists one value for each conditional mode (but not for the normal mode). It will be noticed that this example does not read the headings of the various sections of the configuration file 214, and consequently the sequence of the entries in the configuration file 214 becomes important. It will be realized by those with ordinary skill in the art that more sophisticated solutions are within the scope of the invention. The example does not illustrate how the other values of the configuration file are read.

The following code section illustrates how the program execution unit 220 receives data indicating the actual window size from the state-detecting unit 250. A variable is set to indicate which rendering mode should be selected. A loop is then executed, and every time the conditional expression indicates that the actual window size is smaller than a minimum window size, the indicator is reduced with one. This will result in a number between 0 and 4, inclusive, which will indicate which rendering mode to apply, as indicated by the switch statement.

It must be understood that the above example is exemplary only, and it should not be interpreted as limiting on the many ways similar functionality can be realized using various programming schemes.

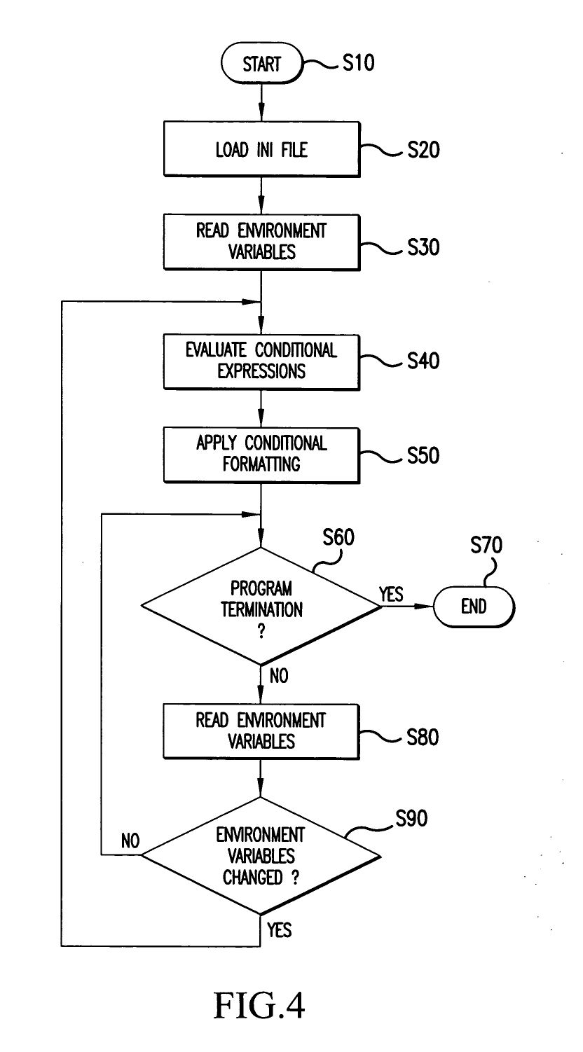

Reference is now made to FIG. 4, which shows a flow chart of how a device operating according to the invention is capable of dynamically implementing different modes of operation. In a first step S10 the computer program 212 is started. Based on instructions in the computer program 212, the program execution unit 220 in a next step S20 loads all the relevant values that can be found in the configuration file 214. In a similar manner the program execution unit in a step S30 reads, or otherwise receives, data indicative of the operating conditions of the device 200 or the computer program 212, for example, in the form of environmental variables. These values can be received from any part of the device's hardware and/or software as applicable, but for the sake of simplicity it will be assumed that the relevant values are reported by a state-detecting unit 250. As soon as all relevant values are available to the program execution unit 220, conditional expressions in the code of the computer program 212 can be evaluated in step S40, and any conditional formatting dictated by the results of these evaluations can be applied, as illustrated in S50. If the program reaches a point where it is terminated S60 the execution of the computer program code will end S70. However, as long as the program keeps running, the relevant environmental variables are continuously monitored S60, for example, by regular polling of the state detection unit 250 by the program execution unit 220.

As long as the environmental variables are unchanged the program keeps running in the same mode until it terminates. However, as illustrated in step S90, when a change in an environmental variable, or any other change in a value that may have impact on the mode in which the computer program 212 is operating, is detected, the relevant conditional expressions will again be evaluated S40. If the change indicates that a different operation mode should take effect, this is again applied in step S50.

It will be understood that this example is illustrative only, and not intended to impose any limitation on the present invention. For instance, the reading of environmental variables does not have to occur regularly, but they may occur only when they are relevant. As an example, it would not be necessary to check conditions applicable only to font sizes if there are no fonts to display in a document opened by the computer program 212.

It will also be understood that while the above examples only illustrate how different variables change value, these changes may take effect on which parts of the computer program 212 should actually be executed. As an example, if image resizing does not apply, no image resizing algorithm is executed. Conversely, if an image is to be resized, relevant program code in the computer program 212 can be loaded and executed by the program execution unit 212.

While most of the examples above have been dealing with window size, it will be understood that other variables and parameters may be taken into consideration in order to determine the operating mode of the computer program 212. Type codes describing the type and format of received data have already been mentioned. Another alternative is screen orientation. This could easily be implemented by applying the same rules for window size even though new window sizes become possible. However, it could also be desirable to apply entirely different formatting rules in landscape mode than in portrait mode. It would also be possible to define criteria based on document content. One example could be to apply more aggressive reformatting when the content is such that it requires horizontal scrolling.

Another criterion for selecting the operating mode, such as one out of several possible rendering modes, could be the type of display used. A wide variety of display types exist, including LCD displays, CRT monitors, television screens of various types, plasma screens, projectors, etc. These different devices may differ widely in various ways such as resolution, refresh rate, contrast, color depth, etc. Similar considerations could apply to audio systems that may be monophonic, stereophonic, surround sound systems, and with our without the capability of implementing different types of audio effects, playing different media types, etc.

According to one embodiment of the invention, one of the parameters of a rendering mode is minimum text contrast. Minimum text contrast is a minimum allowable difference in brightness between text and background colors. If normal rendering results in a text contrast less than the minimum text contrast allowable in that rendering mode, the text color, the background color or both will be adjusted so that the minimum text contrast requirement is fulfilled.

Different algorithms for calculating text contrast may be used. One algorithm has been described in the document titled “Techniques for Accessibility Evaluation and Repair Tools” published by the World Wide Web-Consortium (W3C), which is hereby incorporated by reference. This algorithm determines color brightness as follows:
((Red value×299)+(Green value×587)+(Blue value×114))/1000

A condition for whether to apply minimum text contrast or not could be whether or not the display is, or operates as, a black and white or monochrome display, or based on a setting selected by a user with color deficits.

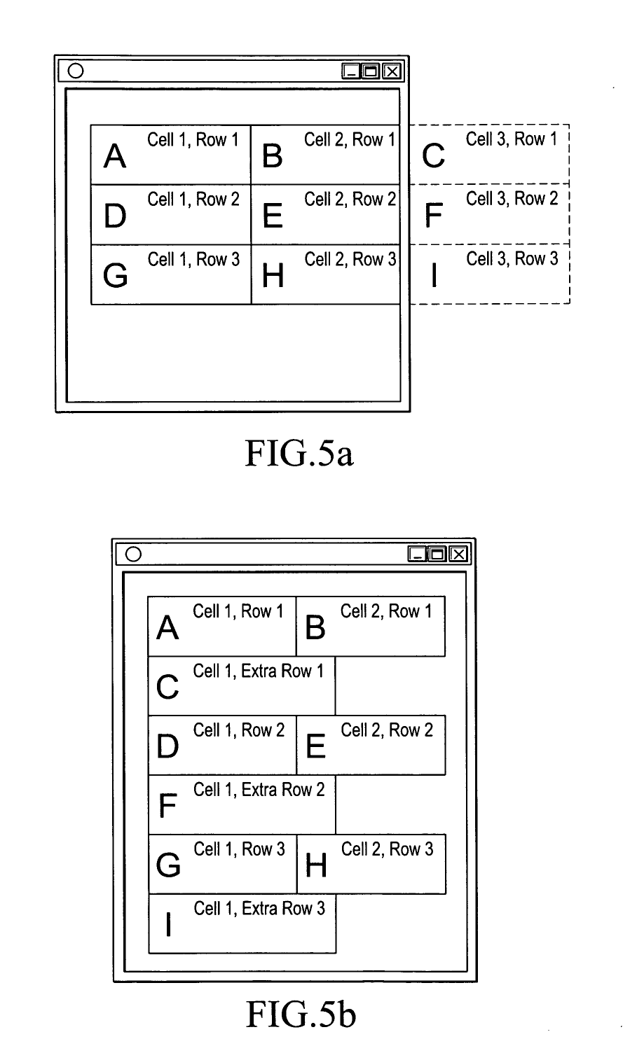

According to another embodiment of the invention, a formatting rule that may apply in one or more rendering modes will be referred to as table column shifting. Table column shifting is a method for reformatting tables that are wider than a display, display area, e.g. a containing block, or window on which it is displayed. This is illustrated in FIG. 5, where in FIG. 5a a 3×3 table is illustrated along with the size of a window in which it is displayed. The parts of the table falling outside the window is shown with dashed lines. The results of the column shifting according to the invention is illustrated in FIG. 5b. Here, extra table rows are generated, and the cells that fall outside the display area or window are shifted to the additional table rows. Any vertical alignment between shifted cells is maintained. It would, of course, be possible to apply cell resizing in addition to column shifting.

It will be understood that in general, some configuration values are given as conditions that are used to determine the correct conditional operating mode, while other configuration values represent values that take effect when a given operating mode applies. One example that has been presented is the case where window size determines rendering mode, and a given maximum font size then applies. However, some parameters may be used either as conditions or as formatting variables. For example, the rendering mode could be dictated by screen orientation and table column shifting could be applied depending on the rendering mode, such that table column shifting is a result of the orientation of the screen. On the other hand, table width could dictate a rendering mode that changes the orientation of the screen, i.e. when the table is wider than a certain minimum, the display shifts from portrait to landscape.

Another example could be minimum text contrast. One alternative is described above, where in a given rendering mode higher text contrast is enforced. Alternatively, the rendering mode could be determined by the text contrast in the document such that if text contrast is below a certain minimum a rendering mode with larger fonts applies.

As such, the present invention is intended to cover all variations and modifications that would be obvious to one of ordinary skill in the art. Such variations are not to be regarded as a departure from the spirit and scope of the invention, and are intended to be included within the scope of the following claims.

What is claimed is:

1. A method for providing a computer program with the ability to adapt to a device on which it is installed, comprising:
providing in the code of said computer program one or more conditional expressions for selecting one out of a plurality of operational modes for said program;
providing, on said device, one or more configuration values to be included in said conditional expressions, at least some of said configuration values defining conditions for transitions between said plurality of operational modes; and
during execution of said program, providing as input to said conditional expressions, values representing one or more states in which the device is operating.

2. The method according to claim 1, wherein said configuration values are included in the code of said computer program.

3. The method according to claim 1, wherein said configuration values are included in a configuration file stored on said device.

4. The method according to claim 1, wherein said configuration values are downloaded from a remote location with which the device is capable of communicating.

5. The method according to claim 1, wherein at least some of said configuration values define parameters to be applied in a given operational mode.

6. The method according to claim 1, wherein at least some of said configuration values are associated with a display of said device.

7. The method according to claim 6, wherein at least some of said configuration values define one or more minimum or maximum values that will override formatting native to a document displayed on said display by said computer program when said computer program is operating in a given operational mode.

8. The method according to claim 7, wherein said configuration values include one or more of a maximum font size, a maximum number of text columns, whether or not images should be displayed, minimum text contrast, and a set of rules for table reformatting.

9. The method according to claim 8, wherein the rules for table reformatting include shifting one or more columns in a table that falls outside a display area such that the shifted one or more columns are positioned visibly within the display area in an additional row directly adjacent to the row from which the shifted column originated.

10. The method according to claim 1, wherein said values representing a state is one or more of an environment variable, and type data.

11. The method according to claim 10, wherein said environment variable is indicative of the width of a window displayed on said display.

12. The method according to claim 1, wherein said computer program is a program capable of rendering on a device display a representation of a document present on said device as one of a markup file and a word processing file.

13. The method according to claim 12, wherein said operational modes include alternative sets of rules for the spatial representation of said markup file or word processing file on said display device.

14. The method according to claim 12, wherein said markup file is a file encoded according to a markup language such as SGML, WML, HTML, DHTML, XHTML or XML.

15. A device in which an adaptable computer program is implemented, comprising:
a memory that stores program code containing conditional expressions for selecting one out of a plurality of operational modes for said program, and configuration values associated with said conditional expressions;
an execution unit that obtains and includes said configuration values from the memory and that furthermore obtains values representing one or more states in which the device is operating and executes the conditional expressions in the program code using said configuration values and said state representing values as input to said conditional expressions; and
an output unit that presents output data in conformance with the operational mode selected through execution of the conditional expressions in the program code.

16. The device according to claim 15, wherein said memory stores said configuration values as part of said program code.

17. The device according to claim 15, wherein said memory stores said configuration values in a separate configuration file.

18. The device according to claim 15, wherein said memory also stores configuration values that define parameters to be applied when a given operational mode is selected by said execution unit.

19. The device according to claim 15, wherein said configuration values are associated with a display of said device and said output unit is a display.

20. The device according to claim 19, wherein said configuration values define one or more minimum or maximum values that will override formatting native to a document displayed on said display by said computer program.

21. The device according to claim 20, wherein said configuration values include one or more of a maximum font size, a maximum number of text columns, whether or not images should be displayed, minimum text contrast, and a set of rules for table reformatting.

22. The device according to claim 21, wherein the rules for table reformatting include shifting one or more columns in a table that falls outside a display area such that the shifted one or more columns are positioned visibly within the display area in an additional row directly adjacent to the row from which the shifted column originated.

23. The device according to claim 15, further including a state-detecting unit for detecting and reporting the conditions of the device and display associated with the configuration values.

24. The device according to claim 15, further including a communication unit that can communicate and receive data from other devices.

25. The device according to claim 15, further including an input/output unit that can receive data input from a user corresponding to the operation of the display.

26. A computer-readable storage medium comprising an executable adaptable program instruction, comprising instruction for:
providing in the code of said computer program one or more conditional expressions for selecting one out of a plurality of operational modes for said program;
providing, on said device, one or more configuration values to be included in said conditional expressions, at least some of said configuration values defining conditions for transitions between said plurality of operational modes; and
during execution of said program, providing as input to said conditional expressions, values representing one or more states in which the device is operating.

27. The computer-readable storage medium according to claim 1, wherein said configuration values are included in the code of said computer program.

28. The computer-readable storage medium according to claim 26, wherein said configuration values are included in a configuration file stored on said device.

29. The computer-readable storage medium according to claim 26, wherein said configuration values are downloaded from a remote location with which the device is capable of communicating.

30. The computer-readable storage medium according to claim 26, wherein at least some of said configuration values define parameters to be applied in a given operational mode.

31. The computer-readable storage medium according to claim 26, wherein at least some of said configuration values are associated with a display of said device.

32. The computer-readable storage medium according to claim 31, wherein at least some of said configuration values define one or more minimum or maximum values that will override formatting native to a document displayed on said display by said computer program when said computer program is operating in a given operational mode.

33. The computer-readable storage medium according to claim 32, wherein said configuration values include one or more of a maximum font size, a maximum number of text columns, whether or not images should be displayed, minimum text contrast, and a set of rules for table reformatting.

34. The computer-readable storage medium according to claim 33, wherein the rules for table reformatting include shifting one or more columns in a table that falls outside a display area such that the shifted one or more columns are positioned visibly within the display area in an additional row directly adjacent to the row from which the shifted column originated.

35. The computer-readable storage medium according to claim 26, wherein said values representing a state is one or more of an environment variable, and type data.

36. The computer-readable storage medium according to claim 35, wherein said environment variable is indicative of the width of a window displayed on said display.

37. The computer-readable storage medium according to claim 26, wherein said computer program is a program capable of rendering on a device display a representation of a document present on said device as one of a markup file and a word processing file.

38. The computer-readable storage medium according to claim 37, wherein said operational modes include alternative sets of rules for the spatial representation of said markup file or word processing file on said display device.

39. The computer-readable storage medium according to claim 37, wherein said markup file is a file encoded according to a markup language such as SGML, WML, HTML, DHTML, XHTML or XML.
